(19) United States
(12) Patent Application Publication
(10) Pub. No.: US 2010/0294476 A1
(43) Pub. Date: Nov. 25, 2010

(54) TEMPERATURE CONTROLLED VALVE FOR REGULATING COOLING GAS FLOW

(76) Inventors: David Gorni, Michmoret (IL); Eilon Faran, Haifa (IL); Leonid Rubinson, Haifa (IL); Joseph Flomenblit, Holon (IL)

Correspondence Address: YORAM TSIVION, P.O. BOX 1307, PARDES HANNA, 37111, IL

(21) Appl. No.: 12/445,754

(22) PCT Filed: Oct. 16, 2007
(86) PCT No.: PCT/IL07/01241

§ 371 Date: Apr. 16, 2009

(30) Foreign Application Priority Data
Oct. 16, 2006 (IL) 178633

(51) Int. Cl. F16K 31/70; G05D 23/02

(52) U.S. Cl. 165/276; 251/11; 62/51.1

(57) ABSTRACT

An automatic temperature regulating device for controlling the flow of a cooling gas through a conduit. The device consists of a plurality of flaps connected to the conduit and made of a shape memory alloy, whereby when in the austenite phase said flaps are in a relatively open state and when in the martensite phase said flaps are in a relatively closed state.

### FIELD OF THE INVENTION

The present invention is in the field of temperature control. More specifically the invention is a temperature controlled valve for restricting gas flow.

### BACKGROUND OF THE INVENTION

Cryostats of the Joule-Thomson effect type are used to cool devices tat require low temperature for functioning. Cryostats such as disclosed in U.S. Pat. No. 5,077,979 and EP application 0747644A3 use a gas expansion for cooling and a gas flow control to control the temperature obtained. EP patent 0245164B1 discloses a Joule-Thomson type cryostat that employs a shape memory alloy component in the mechanism of gas flow control, in which a bias spring is used to deform a bias spring in the cold.

Shape memory alloy metals (SMA) are typified as exhibiting two distinct crystallographic states (or phases). Each of the states is associated with a specific set of mechanical properties. The technological aspects of this issue are discussed in “Engineering aspects of shape memory alloys”, by T. W. Duerig, K. N. Melton, D. S. Tockel and C. M. Wayman, Butterworth Heinemann, 1990.

Shape memory alloys (SMA) possess characteristic properties at two different phases, namely the austenite state or phase at higher temperatures, and the martensite state or phase, at lower temperatures. In the austenitic state the SMA is rigid, while in the martensite state, the metal is relaxed, softer and stretchable. Typically SMA alloys are made from a combination of copper-zinc-aluminum, or copper-nickel-aluminum or nickel-titanium combinations.

If deformed in the colder temperatures, at the martensite state, an SMA metal tends to return to the original form in warmer temperatures, in which the austenite state prevails. The temperature limits of the martensite and austenite state, are defined largely by the nature of the alloy used.

In the present application, the cooling gas flow is used to change the shape of a SMA component directly, to control the cooling gas flow.

### BRIEF DESCRIPTION OF THE DRAWINGS

FIG. 1A is a schematic isometric view of a valve and a gas conduit in which the valve is opened facilitating cooling gas flow.

FIG. 1B is a schematic isometric view of a valve and a gas conduit in which the valve is closed, preventing cooling gas flow.

FIG. 2A is a schematic isometric view of the flaps of a valve of the invention in a projected conformation.

FIG. 2B is a schematic isometric view of the flaps of a valve of the invention in a relaxed conformation.

FIG. 3A is a schematic view of a cross section in a conduit terminated by a valve of the invention showing flaps in a projected conformation.

FIG. 3B is a schematic view of a cross section in a conduit terminated by a valve of the invention showing flaps in a relaxed conformation.

### DETAILED DESCRIPTION OF THE PRESENT INVENTION

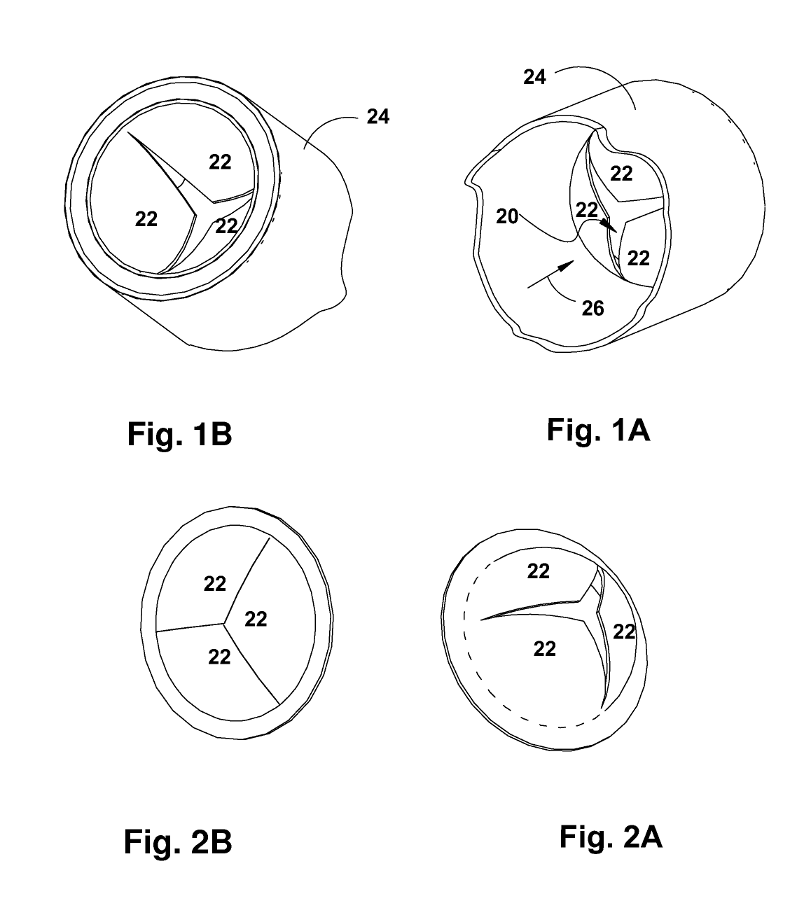

The present invention is embodied in an automatic regulative component that implements a certain restrictive rule on the flow of cooling gas through a conduit. An embodiment of the invention is shown in FIG. 1A, comprising a valve aperture 20, and valve flaps 22 that terminate a conduit or tube 24. Flaps 22 limit the extent of aperture 20. Arrow 26 designates the direction of flow of cooling gas in the gas conduit. In FIG. 1B, the same conduit and valve are shown from the front side of the tube, and flaps 22 project toward the inside (inlet) of tube 24.

In FIGS. 2A-B, only the valve is shown disregarding the attached conduit. In FIG. 2A the valve is shown opened at a relatively high temperature, within the limits of the austenite state, and in FIG. 2B the valve is shown closed, within the limits of the martensite state, when the cooling gas has passed through the valve opening and cooled the flaps, bringing about a martensite state, in which, under pressure of the cooling gas the flaps lose rigidity and bend under the gas pressure.

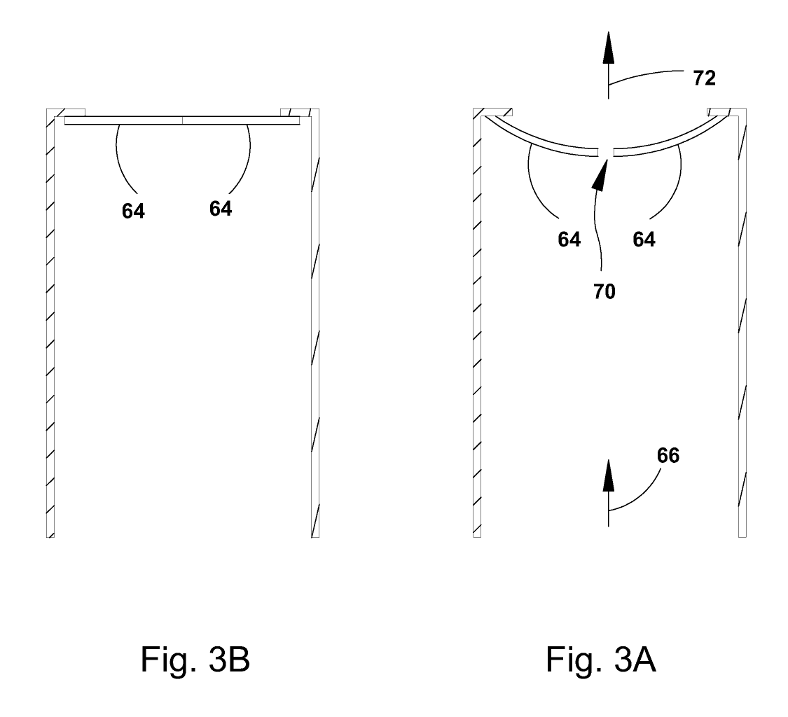

The valve and control of cooling in accordance with the present invention is better illustrated in FIG. 3A-B showing a cross sectional view through a conduit of cooling gas and a valve consisting of flaps 64 made of SMA selected to conform with the range of temperatures anticipated in the specific system. In the higher temperature range, as can be seen in FIG. 3A, the austenite phase prevails, and flaps 64 exhibit an inwardly projecting conformation, allowing cooling gas to flow in the direction of arrow 66 within the conduit, and out of aperture 70 in the direction of arrow 72. The cold flow can then reach an object requiring cooling. Once the flaps 64 are cooled, as is schematically depicted in FIG. 3B, the flaps relax; losing their conformation whereby aperture 70 (of FIG. 3A) is closed down or at least diminished in size.

A variety of alloys are available that provide a wide range martensite and austenite limits for matching the proper temperature range required for obtaining a control over the cooling temperature range.

1. A automatic temperature regulating device for turning on and off a flow of cooling gas through a conduit wherein the flaps of said regulative are made of memory shape metal alloy and wherein in the austenite phase said flaps are projected towards the direction of the flow of said gas, and wherein in the martensite phase of said flaps the flaps are relaxed.

2. A device as in claim 1 wherein said cooling gas is operative in a Joule-Thomson effect apparatus.

3. A device as in claim 2 wherein said apparatus is a cryostat.

4. A method for controlling a flow of cooling gas through a cooling gas conduit, wherein a valve having an aperture limited by flaps made of shape memory alloy is installed in said cooling gas conduit, and wherein said cooling gas flow cools down said flaps of said valve, causing a relaxation of the conformation of said flaps of said valve further causing loss of conformation of said flaps thereby causing closing of the aperture of said valve.
